(19) United States
(12) Patent Application Publication
(10) Pub. No.: US 2009/0163047 A1
(43) Pub. Date: Jun. 25, 2009

(54) Connector having both press-fit pins and high-speed conductive resilient surface contact elements

(76) Inventor: Myoungsoo Jeon, Fremont, CA (US)

Correspondence Address: IMPERIUM PATENT WORKS, P.O. BOX 587, SUNOL, CA, 94586, US

(21) Appl. No.: 12/005,249

(22) Filed: Dec. 24, 2007

(51) Int. Cl. H01R 12/00; H01R 12/34; H01R 13/514

(52) U.S. Cl. 439/65; 439/493; 439/701

(57) ABSTRACT

A connector has a two-dimensional array of Press-Fit Pins (PFPs) and Conductive Resilient Surface Contact Elements (CRSCEs). Within the connector is a set of signal conductors. Each conductor is connected to a corresponding one of the PFPs or the CRSCEs. When the connector is attached to a printed circuit board (PCB), the PFPs extend into and engage corresponding plated through-holes in the PCB. As the PFPs are inserted into the through-holes, the CRSCEs contact the surface of the PCB and are compressed between the connector and the PCB so that each CRSCE makes an electrical connection between a pad on the PCB and a corresponding conductor in the connector. The retention force of the PFPs holds the CRSCEs in their compressed condition. The connector need not be soldered to the PCB, and solder bridging problems and breaking problems associated with solder tails and solder balls are avoided.

### BACKGROUND INFORMATION

FIG. 1 (Prior Art) is a perspective view of a backplane connector assembly. A daughter board connector 1 disposed on a daughter board printed circuit board 2 is mated with a mother board connector 3 disposed on a mother board printed circuit board 4.

FIG. 2 (Prior Art) is a perspective view of the daughter board connector 1 of FIG. 1. Daughterboard connector 1 is fixed to daughter board printed circuit board 2 by an array of press-fit pins. The press-fit pins are used both for mechanically connecting connector 1 to printed circuit board 2 and for electrically connecting signal and ground conductors within connector 1 to corresponding signal and ground conductors in printed circuit board 2.

FIG. 3 (Prior Art) is a more detailed view of portion 5 of FIG. 2. A two-dimensional array of press-fit pins, including press-fit pin 6, is seen extending from a bottom surface of an insulative housing 7 of the connector 1. These press-fit pins are generally pins that have been stamped from a single piece of sheet metal. The pins have a thickness of approximately 0.2 millimeters or more.

FIG. 4 (Prior Art) is a simplified cross-sectional view that shows press-fit pin 6 of connector 1 when the connector 1 is attached to printed circuit board 2. Although the press-fit pin connection mechanism is relatively strong, the press-fit pin connection mechanism has relatively poor electrical signal propagation properties due in part to the length of press-fit pin 6 and the length of the associated plated through-hole 8. Accordingly, connectors of the type illustrated in FIG. 1 are generally not suitable in high speed signaling applications.

FIG. 5 (Prior Art) is a perspective view of another type of daughter board connector 9 referred to here as a surface mount (SMT) connector. Rather than having press-fit pins that engage plated through-holes in a printed circuit board, SMT connector 9 has what are referred to as solder tails.

FIG. 6 (Prior Art) is a more detailed view of portion 10 of FIG. 2. A two-dimensional array of solder tails, including solder tail 11, is seen extending downward from a bottom surface of an insulative housing 12 of connector 9.

FIG. 7 (Prior Art) is a simplified cross-sectional diagram that shows connector 9 fixed to a printed circuit board 13. The solder tail structure of FIG. 7 is generally electrically superior to the press-fit pin structure of FIG. 4 due to there being no long plated through-hole in the structure of FIG. 7. Note that a smaller diameter plated through-hole that acts as a conductive via 14 in the structure of FIG. 7 is short because part of it has been removed by back drilling away part of printed circuit board 13. Back drilled hole 15 is the result of back drilling. The solder tail is surface mount soldered by an amount of solder 16 to a conductive pad 17 on the top of printed circuit board 13.

FIG. 8 (Prior Art) is a perspective view of another type of SMT daughterboard connector 18. The surface mount attachment terminals of connector 18 are solder balls.

FIG. 9 (Prior Art) is a more detailed view of portion 19 of FIG. 8. A two-dimensional array of solder balls, including solder ball 20, is seen extending downward from a bottom surface of an insulative housing 21 of connector 18.

FIG. 10 (Prior Art) is a simplified cross-sectional diagram of connector 18 that shows connector 18 fixed to a printed circuit board 22. The solder ball 20 is soldered to a metal pad 23A on the top of printed circuit board 22 by an amount of solder 23.

FIG. 11 (Prior Art) is a simplified cross-sectional view of an SMT connector 24 that is being soldered to a printed circuit board 25. The soldering process used here involves applying a thickness of solder paste 26 to the upper surface of printed circuit board 25. The connector 24 is then brought down such that the bottom surfaces of the surface mount attachment structures (solder tails or solder balls) ideally contact the solder paste 26. Unfortunately, due to the bottom surfaces of the surface mount attachment structures 27 not being in the same plane, and due to warpage of the printed circuit board 25, there may be places where surface mount attachment structures do not touch the solder paste. Moreover, there may be places where certain ones of the surface mount attachments structures 27 press down into the solder paste so far that local amounts of the solder paste are forced up between adjacent surface mount attachment structures. During subsequent reflow operations, solder bridges are left between these adjacent surface mount attachment structures. This is undesirable. It can be very difficult or impossible to rework or repair solder bridging underneath a large connector when the connector is soldered to a printed circuit board.

FIG. 12 (Prior Art) illustrates another problem with the conventional SMT connectors 9 and 18. When the daughter board upon which the connector is disposed is made to mate with the corresponding mother board connector on the mother board, the required insertion force may result in a shear force on the surface mount attachment structures. Arrow 28 illustrates this shear force. The force may result in the surface mount attachments structure being broken away from the printed circuit board as illustrated.

FIG. 13 (Prior Art) illustrates such breaking in the situation of the surface mount attachment structures being solder balls. The SMT connectors 9 and 18 of FIGS. 5 and 8 generally have superior electrical communication properties as compared to the press-fit pin connector 1 of FIG. 2, but solder bridging can occur and shear forces exerted on the surface mount attachment structures can cause breakage.

### SUMMARY

A connector assembly includes a first connector (for example, a daughter board connector) and a second connector (for example, a mother board connector). Each connector connects to an associated printed circuit board (PCB) via its own two-dimensional array of press-fit pins and Conductive Resilient Surface Contact Elements (CRSCEs). Within the connector is a set of signal conductors. These signal conductors may, for example, be conductors on a set of flexible printed circuits (FPCs) within the connector. Each of these conductors is connected to a corresponding one of the press-fit pins or the CRSCEs in the two-dimensional array. When the connector is attached to its corresponding PCB, the press-fit pins extend into and engage corresponding plated through-holes in the PCB. As the press-fit pins are inserted further into the through-holes, the CRSCEs contact the surface of the PCB and are compressed between the connector and the PCB so that each CRSCE makes an electrical connection between a conductive pad on the upper surface of the PCB and a corresponding conductor in the connector. The retention force of the press-fit pins holds the CRSCEs in their compressed condition. The connector is connected to the PCB without soldering, so solder bridging problems and solder breaking problems associated with solder tails and solder balls are avoided. The press-fit pin connections between the PCB and connector may not be suitable for high speed electrical signaling, but these connections are used for supplying ground potential to the connector and for grounding and shielding purposes. The CRSCE connections are disposed in pairs, and may communicate high speed signals between the PCB and the connector using differential signaling.

Other methods and structures are described in the detailed description below. This summary does not purport to define the invention. The invention is defined by the claims.

### BRIEF DESCRIPTION OF THE DRAWINGS

FIGS. 1-4 (Prior Art) are diagrams of a conventional connector that is attached to a printed circuit board by a two-dimensional array of press-fit pins.

FIGS. 5-7 (Prior Art) are diagrams of a conventional connector that is attached to a printed circuit board by a two-dimensional array of solder tails.

FIGS. 8-10 (Prior Art) are diagrams of a conventional connector that is attached to a printed circuit board by a two-dimensional array of solder balls.

FIGS. 11-13 (Prior Art) illustrate problems associated with the conventional connectors of FIGS. 5-10.

FIG. 14 is a perspective view of a connector in accordance with one novel aspect.

FIG. 15 is a diagram that illustrates some of the press-fit pins and CRSCEs on a substantially planar bottom surface of the connector of FIG. 14.

FIG. 16 is an exploded view of the novel connector of FIG. 14.

FIG. 17 is a perspective view of the second insulative body housing portion 32 of the connector of FIG. 14.

FIG. 18 is a perspective view of the first insulative body housing portion 31 of the connector of FIG. 14. A single FPC assembly is illustrated disposed in its retaining slot in the first insulative body housing portion 31.

FIG. 19 is a side view of a FPC assembly within the novel connector of FIG. 14.

FIG. 20 is a more detailed view of press-fit pins and CRSCEs on the bottom horizontal edge of the FPC of FIG. 19.

FIG. 21 is an exploded perspective view of an FPC assembly of the connector of FIG. 14.

FIG. 22 is a view of the inside of the insulative cover 53 of FIG. 21.

FIG. 23 illustrates a method by which a row of many press-fit pins is attached to the FPC of FIG. 21.

FIG. 24 is an expanded perspective view that shows press-fit pins and CRSCEs extending from the bottom surface of an FPC assembly.

FIG. 25 is a side view of a portion of an FPC assembly. The figure shows how a CRSCE is retained in a slide-channel in the FPC assembly.

FIG. 26 is a side view that illustrates the attachment of the novel connector of FIG. 14 onto a printed circuit board. No soldering is performed.

FIG. 27 illustrates how the press-fit pins engage plated through-holes in the printed circuit board and hold the CRSCEs in a compressed condition.

FIG. 28 (Prior Art) illustrates a solder pad and via pad to prevent a solder wicking of conventional solder tail of a conventional solder tail connection. The result is a somewhat irregular connection into the printed circuit board that has a substantial amount of electrical discontinuity.

FIG. 29 illustrates one way that the CRSCEs connections in the novel connector of FIG. 14 are superior to the connections of FIG. 28.

FIG. 30 is a perspective view that illustrates a connector assembly involving the novel daughter board connector 30 of FIG. 14 and a novel mother board connector 94. The novel mother board connector 94 also involves a two-dimensional array of press-fit pins and CRSCEs.

FIG. 31 is a side view that illustrates how the novel mother board connector 94 attaches to a printed circuit board. No soldering is performed.

FIG. 32 shows the novel mother board connector 94 in its final attached position on the printed circuit board.

FIG. 33 is an expanded view that illustrates the CRSCEs of the mother board connector 94 in their compressed condition.

FIG. 34 is a perspective view of another connector that involves stamped metal signal conductors rather than the novel FPC signal conductors of the embodiment of FIG. 30.

FIG. 35 illustrates how the connector of FIG. 34 is made to include a two-dimensional array of CRSCEs and press-fit pins.

FIG. 36 illustrates one way that CRSCEs can be attached to the ends of stamped metal conductors in a connector such as the connector of FIG. 34.

FIGS. 37-39 illustrate an embodiment of a connector involving a sheet of elastomeric connector material and press-fit pins.

FIGS. 40-41 illustrate a CRSCE involving a spring and a pair of pins.

FIG. 42 illustrates a CRSCE involving a spring having a conductive elastomeric shaft.

FIGS. 43-44 illustrate a CRSCE that is a spring whose turns contact each other.

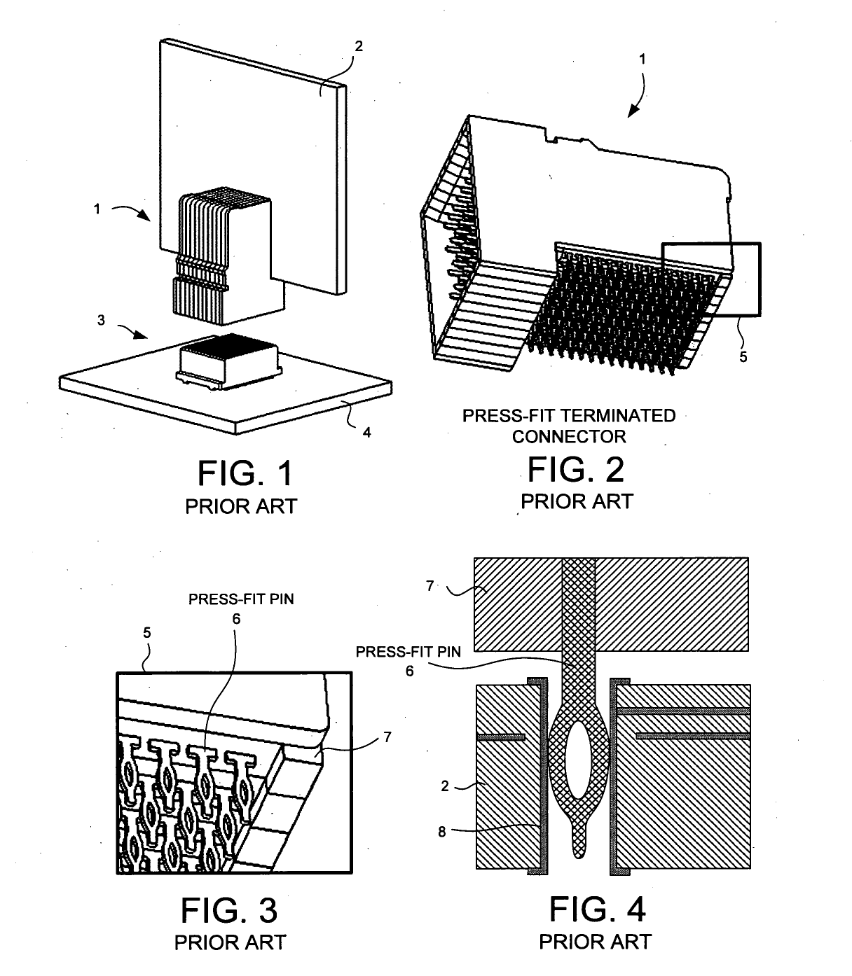

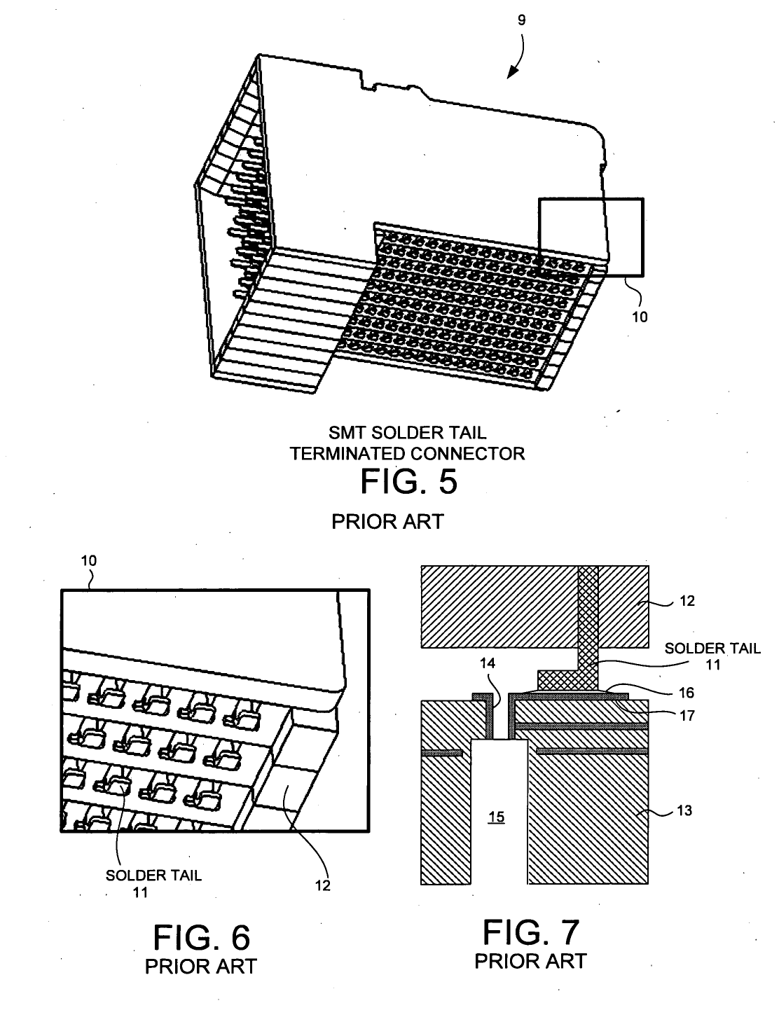

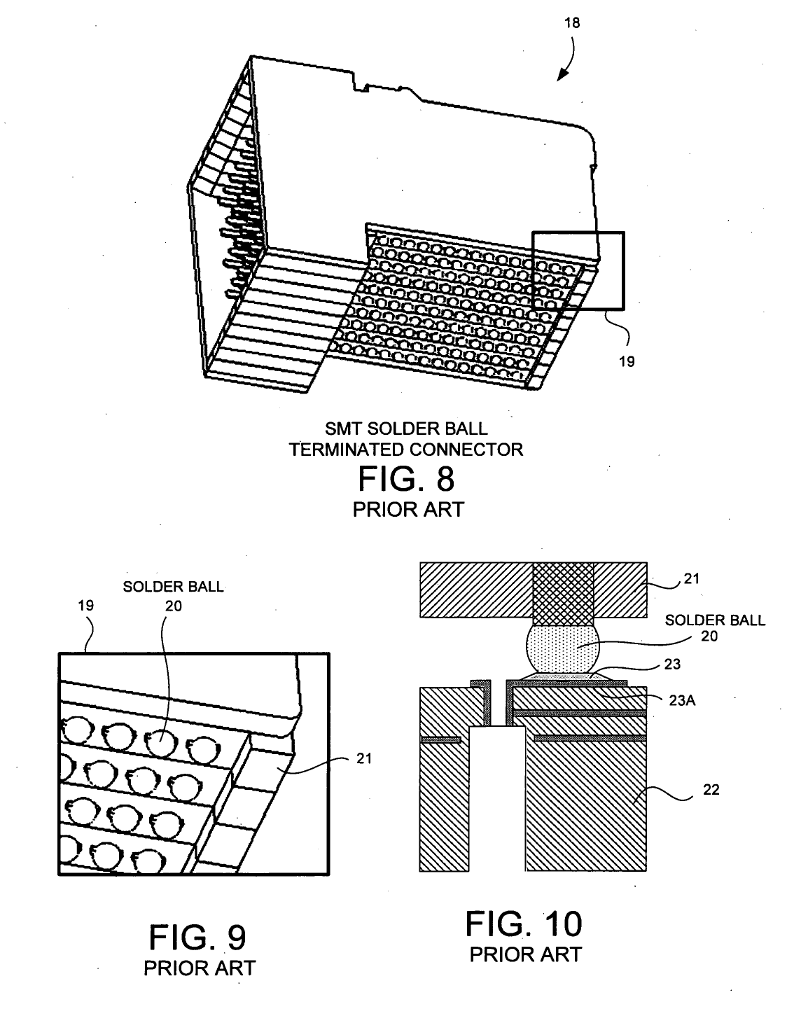

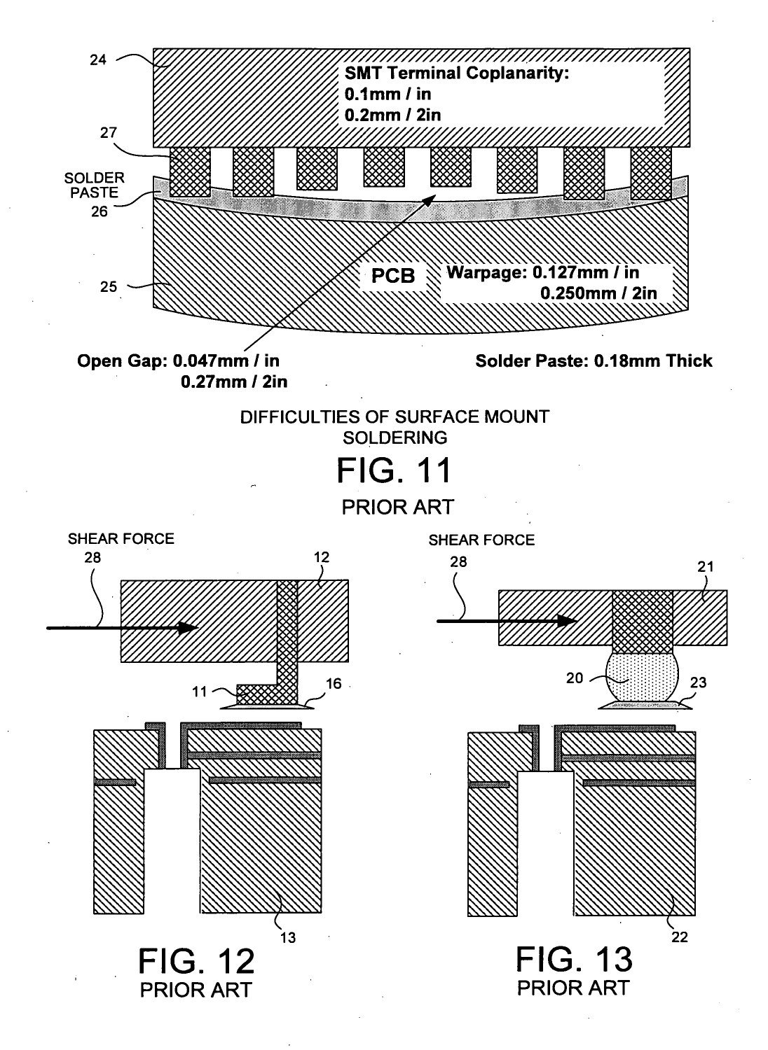

### DETAILED DESCRIPTION

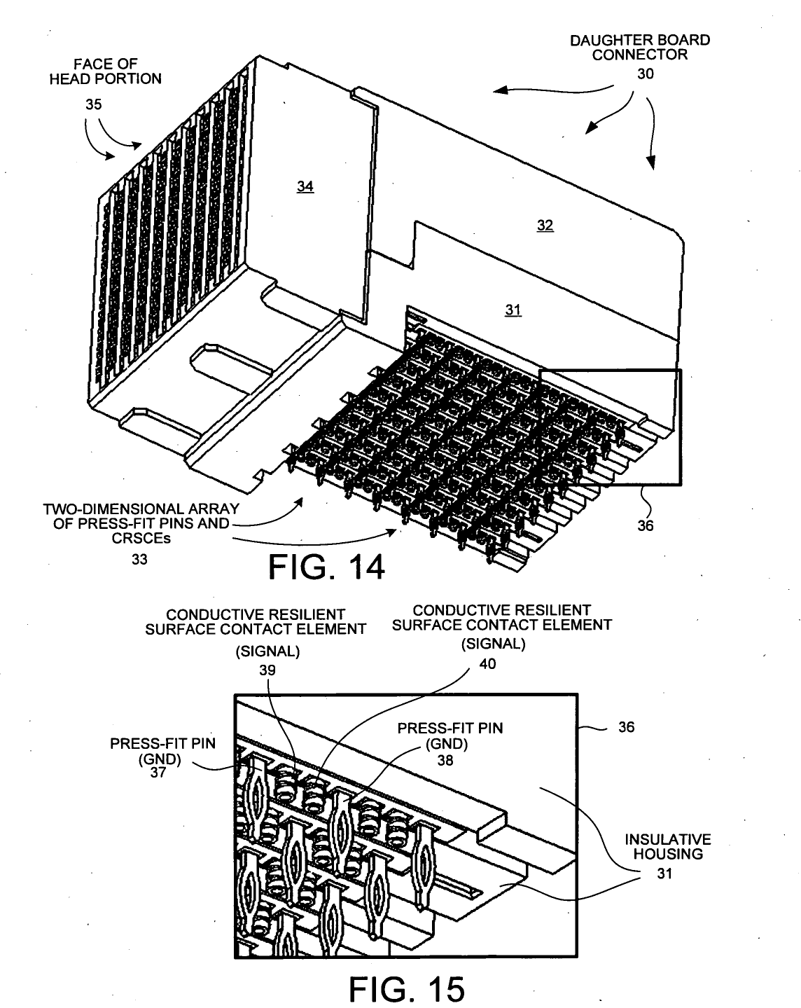

FIG. 14 is a perspective diagram of a novel connector 30. Connector 30 includes a body portion and a head portion. The head portion is movable laterally with respect to the body portion. In the illustrated example, the body portion includes a first insulative body housing portion 31, a second insulative body housing portion 32, and a plurality of flexible printed circuit (FPC) assemblies. The FPC assemblies are held in place and covered by the first and second insulative body housing portions 31 and 32. A two-dimensional array 33 of press-fit pins and “Conductive Resilient Surface Contact Elements” (CRSCE) extends from a bottom surface or side of the first insulative body housing portion 31. Insulative head housing portion 34 can move laterally with respect to the first and second insulative body portions 31 and 32. Within connector 30, each FPC assembly includes a flexible printed circuit (FPC). The FPC includes a plurality of parallel extending conductors disposed on a flexible substrate such as polyimide (Kapton), polyester (Mylar) or Teflon. Each of these conductors is coupled to a corresponding contact beam (not shown) at the face 35 of the head portion, and extends (to the right and then down in the illustration) to a corresponding one of the press-fit pins or CRSCEs at the bottom surface of first insulative housing portion 31. When the head portion of the connector is moved laterally with respect to the body portion of the connector, these FPCs are made to bend to accommodate the lateral movement of the head portion. In this example, the housing portions 31, 32 and 34 are injection molded structures of Liquid Crystal Polymer (LCP) material.

FIG. 15 is a more detailed view of the portion 36 of FIG. 14. FIG. 15 shows a portion of the two-dimensional array 33 of press-fit pins and CRSCEs. Each of the press-fit pins extends downward from the bottom surface of insulative housing 31 as illustrated. Two of these press-fit pins 37 and 38 are labeled in FIG. 15. Each of the CRSCEs also extends downward from the bottom surface of insulative housing 31 as illustrated. Two of the CRSCEs 39 and 40 are labeled in FIG. 15.

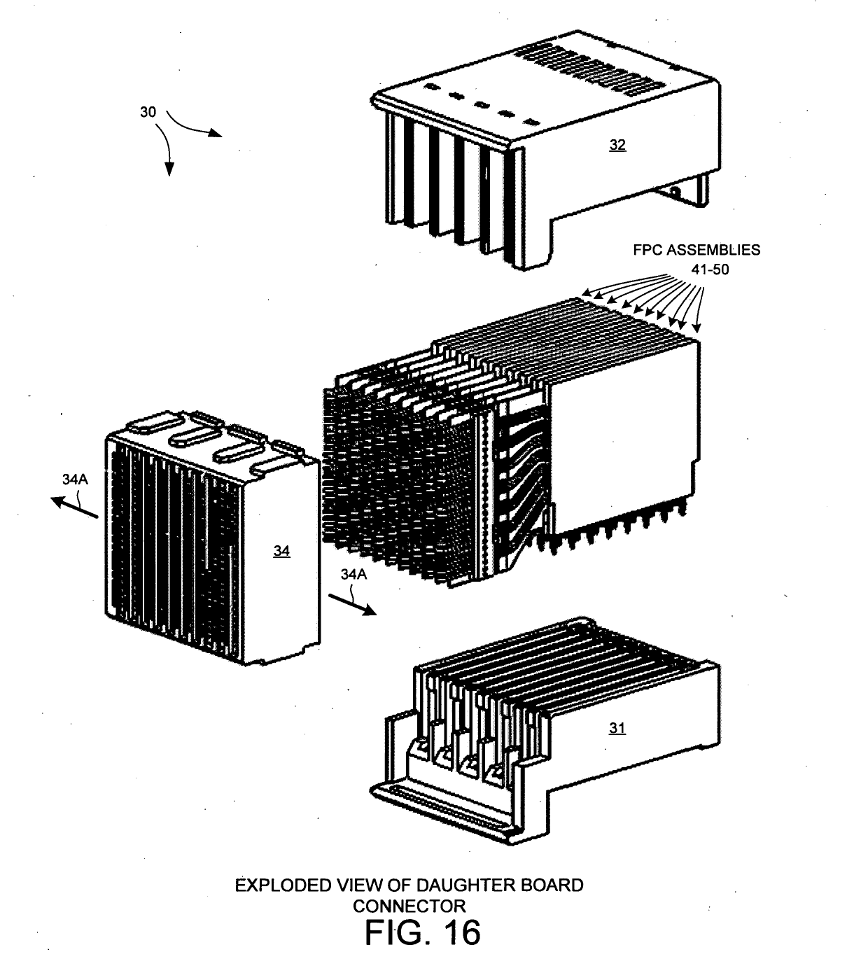

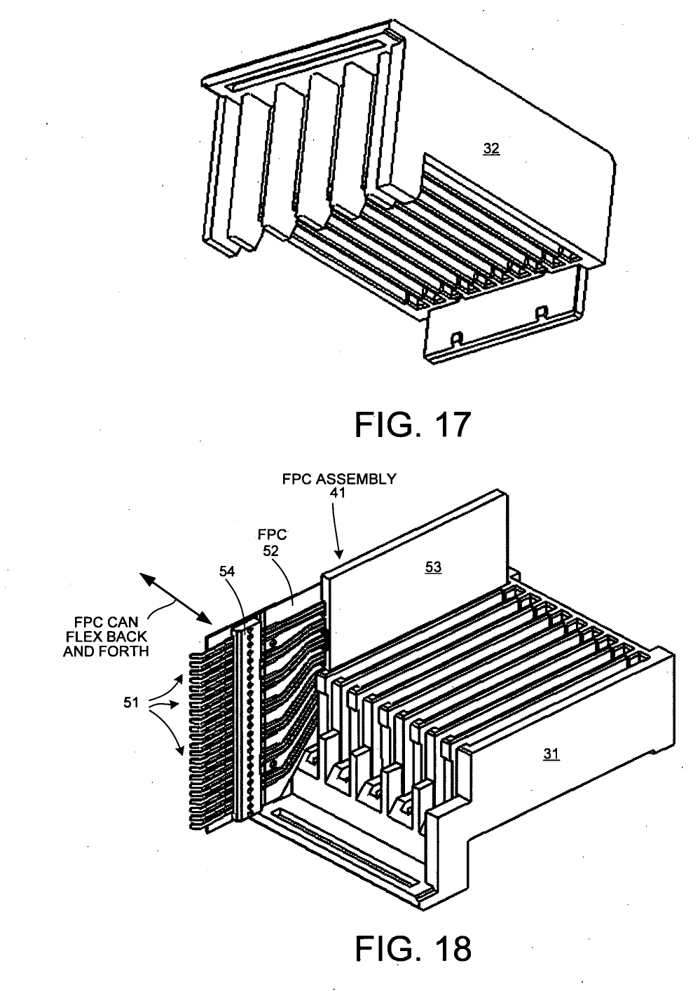

FIG. 16 is an exploded view that shows the plurality of FPC assemblies 41-50 within the connector 30. The FPC assemblies 41-50 are retained in the parallel orientation illustrated by a set of corresponding slots in the first and second insulative housing portions 31 and 32. Each FPC assembly has an associated slot. Insulative head housing portion 34 is shaped as illustrated and has a set of vertically-extending slots. The left facing end of an FPC assembly as pictured in FIG. 16 extends into a corresponding one of the vertically-extending slots in insulative head housing portion 34. In the assembled connector 30, the head portion can move laterally back and forth in the direction of arrows 34A.

FIG. 17 is a larger diagram of second insulative body housing portion 32.

FIG. 18 is a larger diagram showing FPC assembly 41 disposed in its slot in first insulative body housing portion 31. FPC assembly 41 includes a row of contact beams 51 that is aligned along a second edge (vertical edge in the illustration) of the FPC 52 of the FPC assembly 41. FPC assembly 41 also includes an insulative cover portion 53, the FPC 52, and an insulative contact holder 54. FPC assembly 41 also includes a plurality of press-fit pins and a plurality of CRSCEs (not illustrated in the view of FIG. 18).

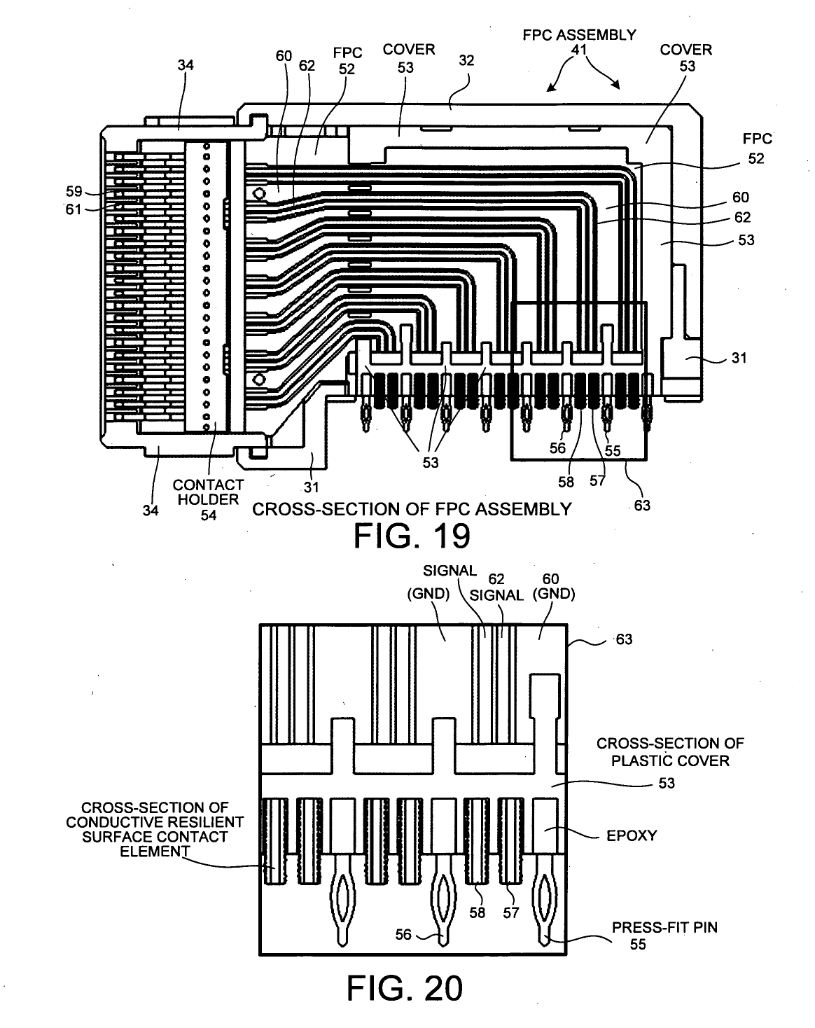

FIG. 19 is a side view of a cross-section of FPC assembly 41. In this illustration, the press-fit pins (two of which are labeled as 55 and 56 in FIG. 19) are illustrated extending downward from a first edge (horizontal bottom edge in the illustration) of the FPC 52 of the FPC assembly 41. In this illustration, the CRSCEs (two of which are labeled as 57 and 58) are illustrated extending downward from the first edge (the horizontal bottom edge) of FPC 52. One of the contact beams 59 is electrically coupled to press-fit pin 55 by a conductor 60 on FPC 52. Another of the contact beams 61 is electrically coupled to CRSCE 57 by another conductor 62 on FPC 52. In, this way, each contact beam along the left edge of FPC assembly 41 makes an electrical connection with a corresponding one of the press-fit pins or CRSCEs along the bottom edge of the FPC assembly 41. Reference numeral 53 in FIG. 19 identifies cross-sectional areas of insulative cover 53. Contact holder 54 is a strip of insulative material that is disposed over the right ends of the contact beams where the contact beams are soldered to their corresponding conductors on FPC 52. Contact holder 54 provides additional mechanical strength to the contact beam solder joints.

FIG. 20 is an expanded view of portion 63 of FIG. 19.

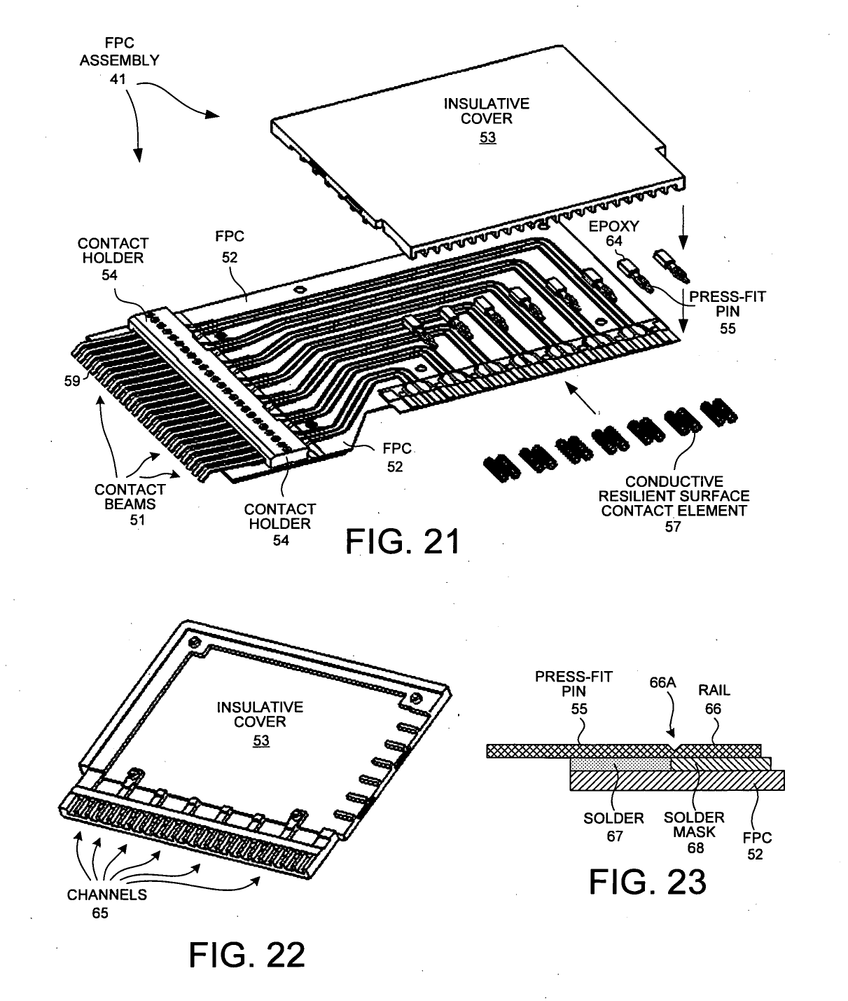

FIG. 21 is an exploded view of FPC assembly 41. An amount of epoxy 64 attaches each press-fit pin to cover 53 to provide additional mechanical support to the solder joint that fixes the press-fit pin 55 to FPC 52.

FIG. 22 is a perspective view of the inside of insulative cover 53. Insulative cover 53 forms a plurality of channels 65. There is one channel for each press-fit pin and one channel for each CRSCE. Each press-fit pin is fixed by epoxy 64 into its associated channel and to cover 53. Each CRSCE is fixed into its associated channel, but is allowed to compress and slide within the channel as explained further below.

FIG. 23 is a cross-sectional view that illustrates how the press-fit pins are attached to FPC 52. A row of press-fit pins is stamped out of a single sheet of sheet metal such that each press-fit pin is attached by its own narrow tab portion to a common rail 66. FIG. 23 shows press-fit pin 55 connected by narrow tab portion 66A to rail 66. The narrow tab portion 66A is thinner than the other parts of the stamped metal as illustrated. The press-fit pins are then soldered to the FPC 52. Solder 67 illustrates the solder that fixes press-fit pin 55 to FPC 52. A solder mask 68 prevents the rail 66 from being soldered to FPC 52. After soldering, the rail 66 is lifted up such that the rail breaks away from the press-fit pins at the narrow tab portions. The result is that all the press-fit pins are separated from each other and are left individually soldered to their appropriate conductors on FPC 52.

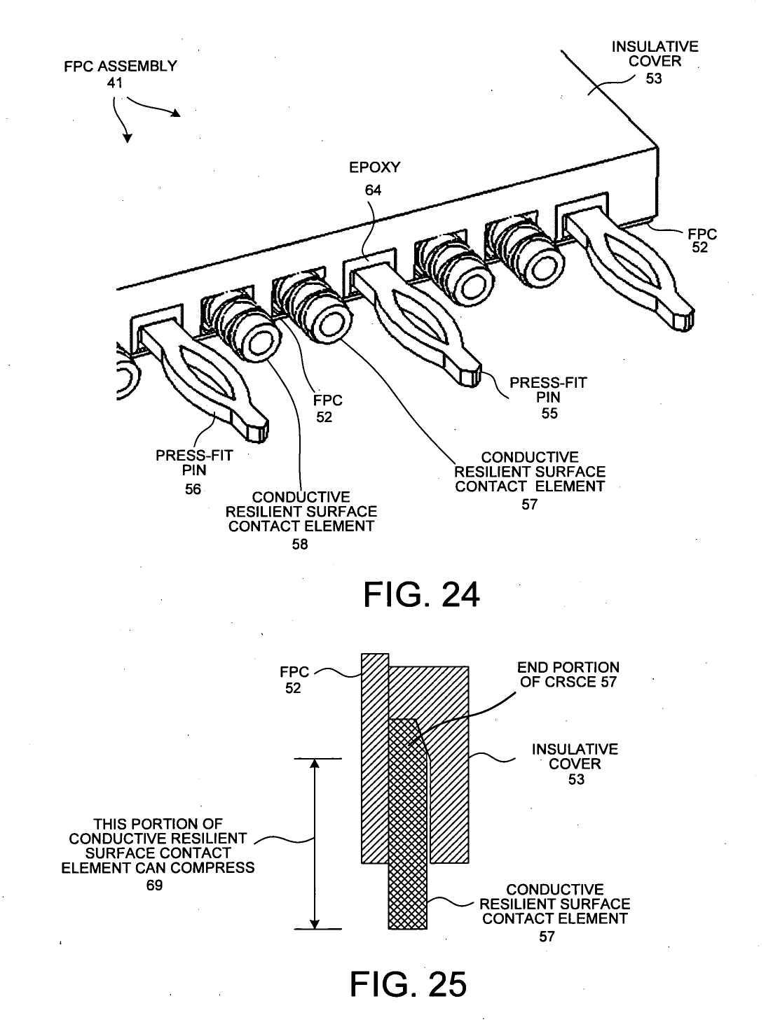

FIG. 24 is a perspective view of a portion of FPC assembly 41. Each conductive resilient surface contact element (CRSCE) is seen disposed in its own channel in insulative cover 53. Each press-fit pin is in its own channel in insulative cover 53, but each press-fit pin is fixed to the channel walls by epoxy adhesive 64.

FIG. 25 is a cross-sectional view that illustrates a CRSCE (for example, CRSCE 57) disposed in its channel. An end portion of the channel is narrower than the part of the channel toward the channel opening. The narrowing is such that the insulative cover 53 pinches an end portion 70 of CRSCE 57 against the FPC 52, thereby holding the CRSCE in place in the channel. The CRSCE 57 has a conductive surface that makes electrical contact with an appropriate conductor on the surface of FPC 52. The remainder of the channel is of a larger cross-sectional area than the cross-sectional area of CRSCE 57 so CRSCE 57 can slide along the sidewalls of the channel in region 69 when CRSCE 57 is compressed.

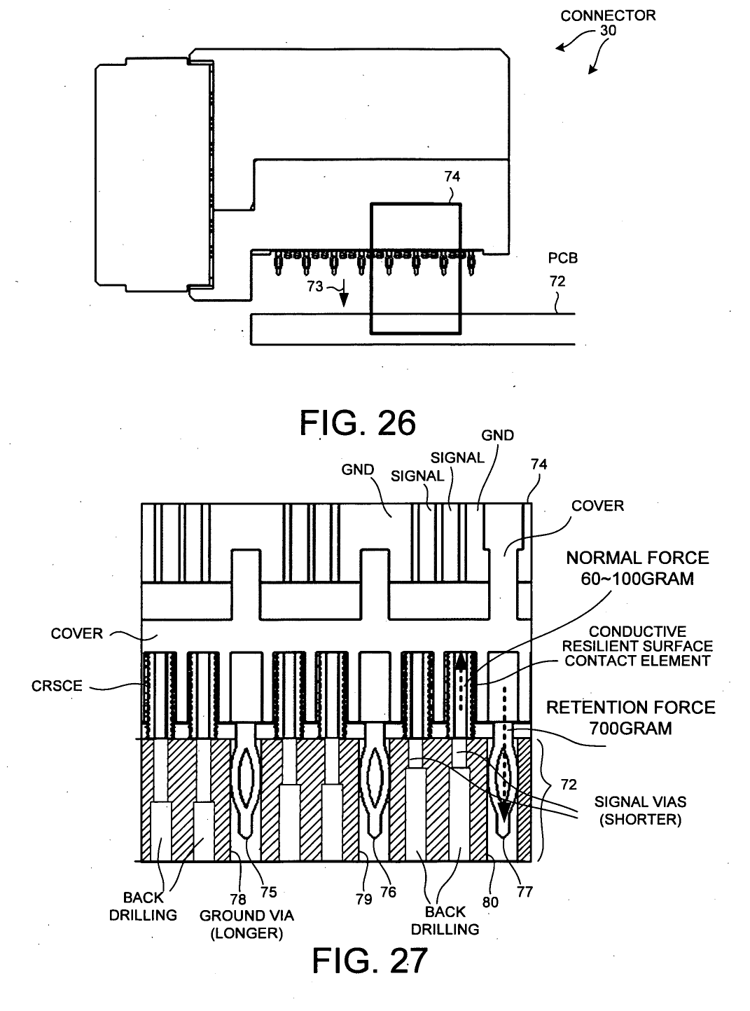

FIG. 26 is a side view showing connector 30 being attached to a printed circuit board 72 (in this case, a daughter board printed circuit board). Arrow 73 represents the movement of connector 30 toward printed circuit board 72.

FIG. 27 is an expanded view of portion 74 of FIG. 26. The press-fit pins of the connector 30 (press-fit pins 75-77 are illustrated) extend into corresponding plated through-holes (through-holes 78-80) in printed circuit board 72. Insertion continues until the bottom contact surfaces of the CRSCEs make contact with associated corresponding conductive pads on the top surface of printed circuit board 72. Insertion continues so as to compress the CRSCEs an appropriate amount. Each CRSCE exerts a normal expansion force of approximately 60 to 100 grams. Each press-fit pin has a retention force (the force necessary to remove the press-fit pin from its through-hole) of approximately 700 grams. There are enough press-fit pins that the combined retention force exceeds the combined expansion normal force of the CRSCEs. The CRSCEs are therefore maintained in their compressed state.

Note that the signal vias to which the CRSCEs couple is made to be short by back drilling the printed circuit board 72 as illustrated. This improves electrical communication characteristics of the CRSCE connections. The CRSCE connections are used to communicate high speed electrical signals other than DC ground and/or power. The press-fit pin connections, on the other hand, are typically used for coupling DC ground potential through the connector and for shielding purposes. Because the press-fit connections do not communicate high speed signals, the press-fit pin connections do not need to have the superior high speed electrical characteristics of the CRSCE connections. In the example of FIGS. 14-33, the terminals along the bottom horizontal edge of FPC 52 involves pairs of adjacent CRSCEs. One such pair may, for example, communicate information using differential signaling. Between each adjacent pair of such adjacent CRSCE pairs is a press-fit pin terminal. This pattern is repeated throughout the two-dimensional array of terminals on the bottom surface of connector 30. In one example, there is at least one press-fit pin terminal for each four CRSCE terminals, and wherein there are at least fifty CRSCEs in the two-dimensional array.

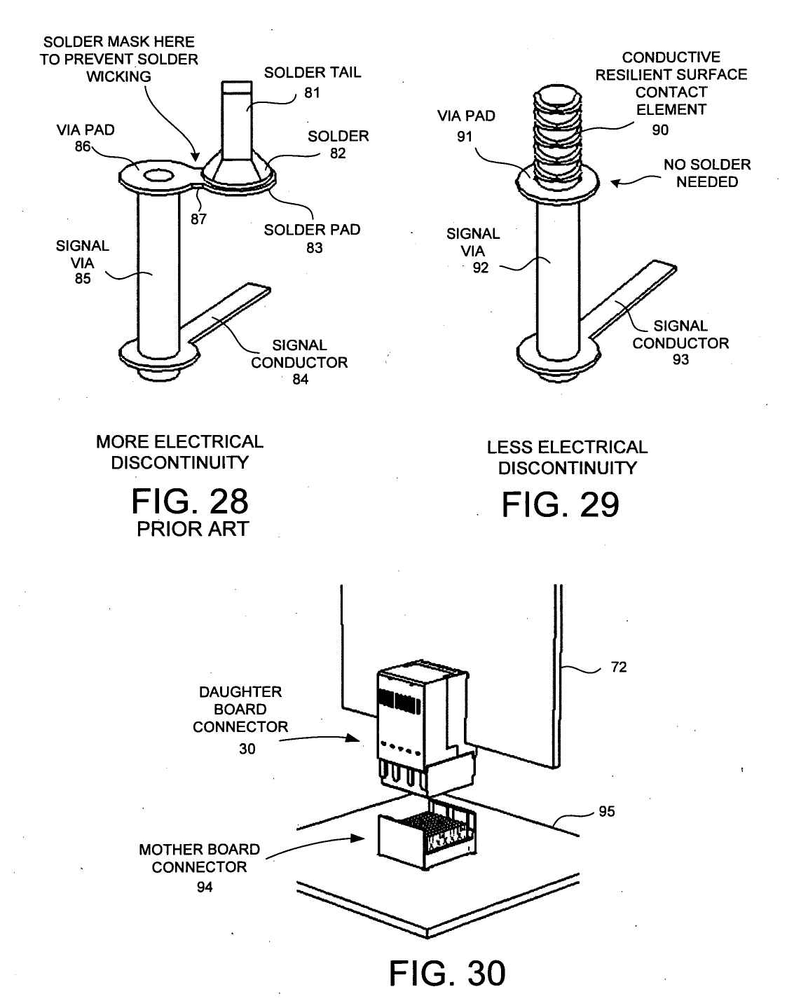

FIG. 28 (Prior Art) illustrates a typical connection in a conventional connector. This connection involves a solder tail or solder ball surface mount attachment structure. The surface mount attachment structure (for example, solder tail) 81 is soldered by an amount of solder 82 to a solder pad 83 on the upper surface of a printed circuit board. The FR4 material of the printed circuit board is not shown in the diagram of FIG. 28 so that the conductors within the printed circuit board will be revealed. The electrical connection extends down to a signal conductor 84 in the printed circuit board through a plated through-hole or “via” 85. If via 85 were disposed directly underneath solder pad 83, then during the reflow process of soldering the solder 82 might be wicked down into signal via 85 and away from the desired solder joint to the solder tail 81. To prevent this, solder pad 83 is offset with respect to signal via 85 and a via pad 86 and short conductor 87 are provided for electrical continuity. The top of via pad 86 and the short conductor 87 are covered with a solder mask (not shown) to prevent the wicking of solder 82 from solder pad 83 into signal via 85. This structure works in preventing solder wicking, but it introduces an amount of electrical discontinuity due to the irregular shape of the connection between solder tail 81 and signal conductor 84.

FIG. 29 is a perspective view that illustrates an advantage of novel connector 30. Due to the use of the novel CRSCEs, no solder is used in fixing connector 30 to a printed circuit board. No solder tails or solder balls need to be soldered to the printed circuit board, rather the CRSCEs of connector 30 make electrical contact to corresponding conductors on the top of the printed circuit board by physical contact. The physical contact is maintained due to the normal expansion forces of the CRSCEs themselves. Because no solder is used, the solder wicking problem of FIG. 28 does not occur, and the signal vias into the printed circuit board are made to align with their respective CRSCEs as illustrated in FIG. 29. FIG. 29 shows a CRSCE 90 of connector 30 disposed directly above and axially aligned with respect to via pad 91 and barrel-shaped signal via 92. Accordingly, the electrical signal path from CRSCE 90 to signal conductor 93 has fewer electrical discontinuities than does the structure of FIG. 28.

FIG. 30 is a perspective view of a novel connector assembly involving the novel daughter board connector 30 of FIG. 14 and a novel mother board connector 94. Electrical conductors on daughter board printed circuit board 72 are connected through connector 30 and connector 94 to corresponding conductors on motherboard printed circuit board 95.

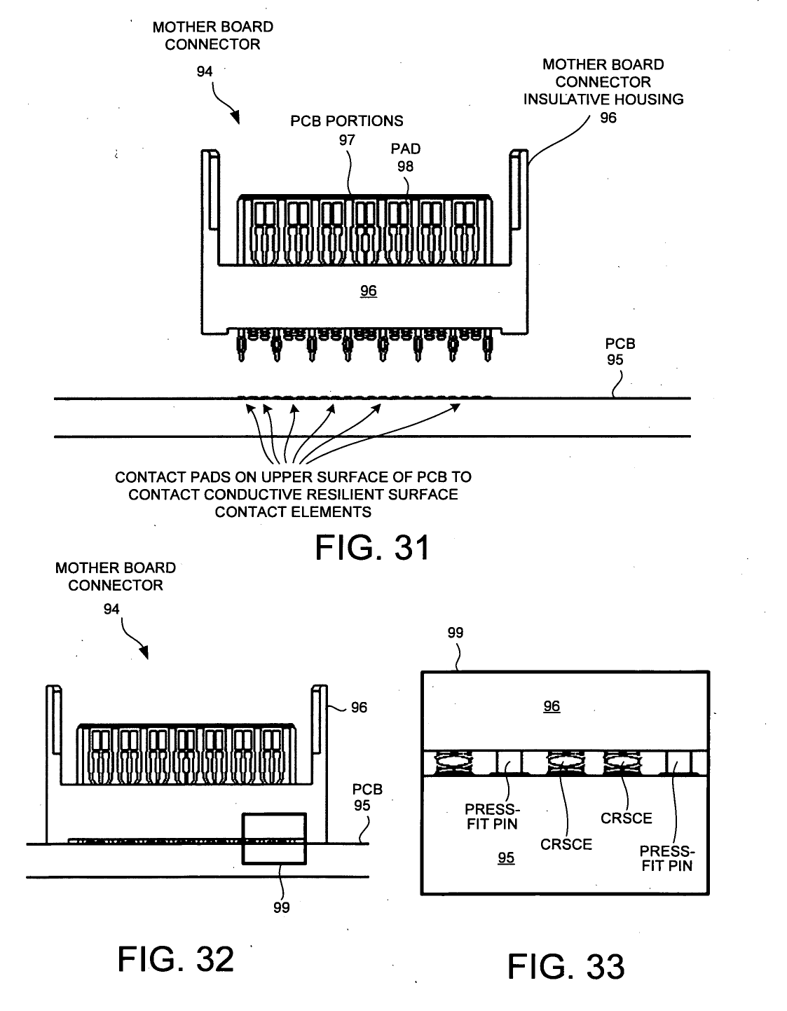

FIG. 31 is a cross-sectional view of mother board connector 94 of FIG. 30. The mother board connector 94 includes an insulative housing 96 and a plurality of PCB assemblies 97. Each PCB assembly includes conductive pads (one pad in FIG. 31 is labeled by reference numeral 98) that engage the contact beams of a corresponding one of the FPC assemblies of the daughter board connector 30. A plurality of press-fit pins is also attached to each PCB assembly of the mother board connector 94 by the method described above in connection with FIG. 23. The PCB assemblies, including their press-fit pins, are then inserted into the insulative housing 96. Once in place, the CRSCEs of the mother board connector 94 are inserted from the bottom (the bottom in the orientation of the illustration of FIG. 31) of the connector 94. When an CRSCE is inserted into its associated channel in the insulative housing 96, a narrowed end portion of the channel (similar to the narrowed end portion illustrated in FIG. 25 above) pinches the CRSCE and holds it in place in the channel and against a conductor of the PCB portion. Automatic insertion equipment known in the art is utilized for this insertion operation. Corresponding ones of the pads (such as pad 98) are connected by conductors on the PCB portions to corresponding ones of the press-fit pins and CRSCEs at the bottom of connector 94. The resulting mother board connector 94 is fixed to printed circuit board 95 in a similar way to the way that connector 30 is fixed to printed circuit board 72 (see the description above in connection with FIG. 27).

FIG. 32 illustrates connector 94 fixed to printed circuit board 95. The press-fit pins engage corresponding plated through-holes in printed circuit board 95 and provide enough retention force that the CRSCEs are maintained in their compressed conditions. The press-fit pins are used to for grounding, whereas the CRSCE connections are used to communicate high speed signals.

FIG. 33 shows the portion 99 of FIG. 32 in further detail. The CRSCEs are illustrated in their compressed conditions, with their respective contact surfaces force down and contacting corresponding contact pads on the top of printed circuit board 95.

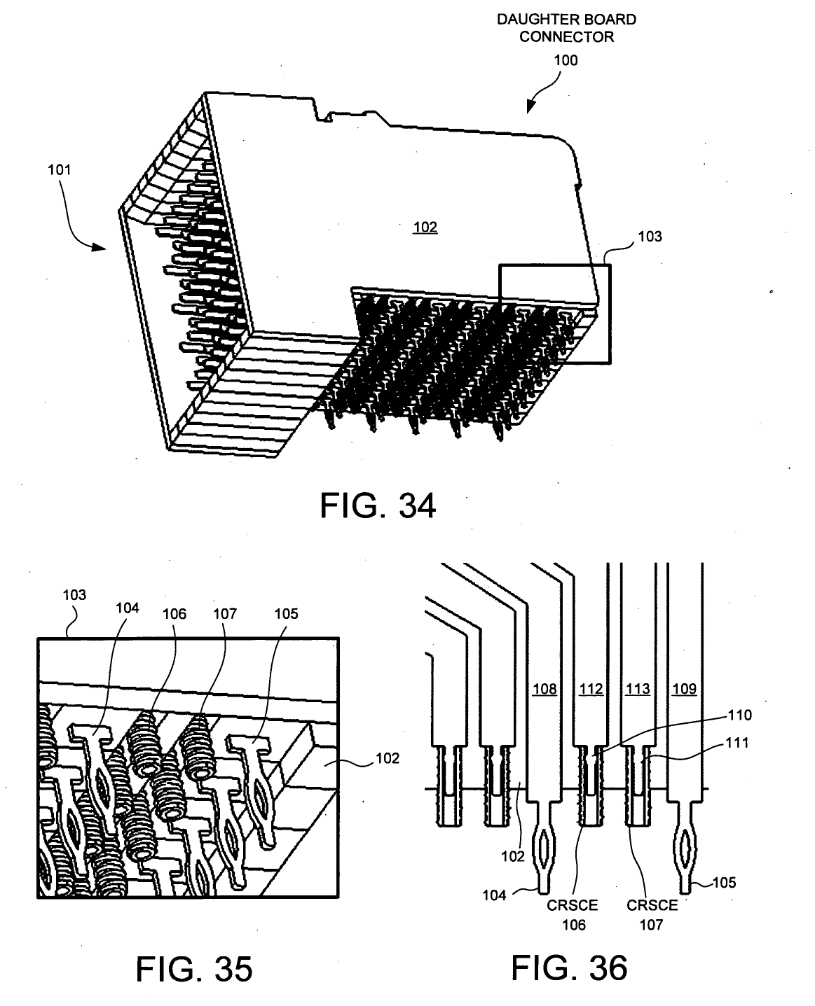

FIG. 34 illustrates another embodiment of a connector 100 employing both press-fit pins and CRSCEs. Connector 100, rather than using flexible printed circuits (FPCs) or printed circuits, employs conductors made of stamped metal. One such stamped metal conductor, for example, extends from a contact beam or contact fork or spring or other contact mechanism on the left face 101 of the connector 100, and extends through the body of connector 100 to the bottom surface of housing 102. There are numerous such stamped conductors in the connector 100.

FIG. 35 illustrates portion 103 of FIG. 34 in further detail. In accordance with one novel aspect, rather than all of the stamped metal conductors being terminated in press-fit pins in conventional fashion, some of the stamped metal conductors are terminated in CRSCEs. Consider, for example, the two press-fit pins 104 and 105 and the two CRSCEs 106 and 107 of FIG. 35. These structures are illustrated in cross-section in FIG. 36. Press-fit pins 104 and 105 are the stamped ends of stamped metal conductors 108 and 109 respectively. These press-fit ends extend beyond the bottom surface of housing 102 and are used to press-fit into receiving plated through-holes in a printed circuit board in standard fashion.

Two other stamped metal conductors 112 and 113, however, have narrow end portions 110 and 111, respectively. These end portions 110 and 111 are adapted to receive and hold CRSCEs. CRSCEs 106 and 107 are disposed over these accommodating narrow portions 110 and 111. In this particular example, CRSCEs 106 and 107 are hollow tubes of a fine wire mesh. The hollow axial openings of these tubes are slid over the narrow portions 110 and 111. Friction between the narrow portions 110 and 111 and the CRSCEs hold the CRSCEs in place. In this way, CRSCEs can be installed over narrow portions at the end of stamped metal conductors rapidly using known automatic assembly equipment. Accordingly, a novel combination of press-fit pins and CRSCEs is employed on a daughter board connector that employs standard stamped sheet metal conductors as opposed to the novel flexible printed circuit conductors of the novel connector 30 of FIG. 14.

The conductive resilient surface contact element (CRSCE) in the above embodiments may be of several different constructions. In one example, the CRSCE is a fuzz button such as a “fuzz button” available from Technit Interconnection Products of Denver, Colo. The CRSCE may be an amount of fine gold plated wire that is compressed and crushed into a cylindrical shape. The cylindrical shape has a diameter of 0.5 millimeters or less, and has a length of 2.0 millimeters or less in its extended (uncompressed) condition, and has a round contact surface area of less than two square millimeters. The wire of which the cylindrical shape is made has a diameter substantially less than 0.1 millimeters. In another example, the CRSCE is a hollow tube of the knitted very fine wire mesh. In another example, the CRSCE is a tube of the knitted very fine wire mesh that surrounds an axially-disposed larger diameter wire or wires. In another example, the CRSCE is a tube of the knitted very fine wire mesh that surrounds an axial shaft of an elastic material.

Although the examples above all include a very fine wire mesh, a CRSCE need not involve such a mesh. For example, a CRSCE may be an amount of a conductive elastic material such as a synthetic rubber material that has dispersed within it enough fine metal powder that the rubber material is conductive. In one example, a CRSCE is an elastomeric connector of the type that includes one or more very fine conductive filaments. The conductive filaments extend in parallel from one round end of the cylindrical shape to the other round end (the surface contact area) of the cylindrical shape. The structures set forth above are just some examples of structures that are suitable to provide the compressible and conductive surface contact function. Other suitable structures can be employed. The surface contact area of a CRSCE may, for example, include a solder tail metal plate structure or an amount of solder or a solder ball as long as the CRSCE has the compressible property and the ability to communicate high speed signals between the PCB and the connector. The CRSCE is not, however, a piece of stamped spring sheet metal two millimeters long that is stamped out of the same sheet of metal as the press-fit pins. The CRSCE may be a spring surrounding an axial shaft of a conductive elastomer that shorts the turns of the spring, a spring surrounding a metal pin that shorts the turns of the spring, or a spring structure whose turns contact one another.

Although the example of a CRSCE set forth above in connection with FIG. 24 is disposed in a channel in cover 53, the CRSCEs in other embodiments are not disposed in channels. Any suitable way of attaching one end portion of a CRSCE to a conductor on FPC 52, so that the CRSCE to conductor joint is mechanically strong enough to resist the compressive forces to be put on the CRSCE when the connector is press-fit inserted onto a printed circuit board, can be employed.

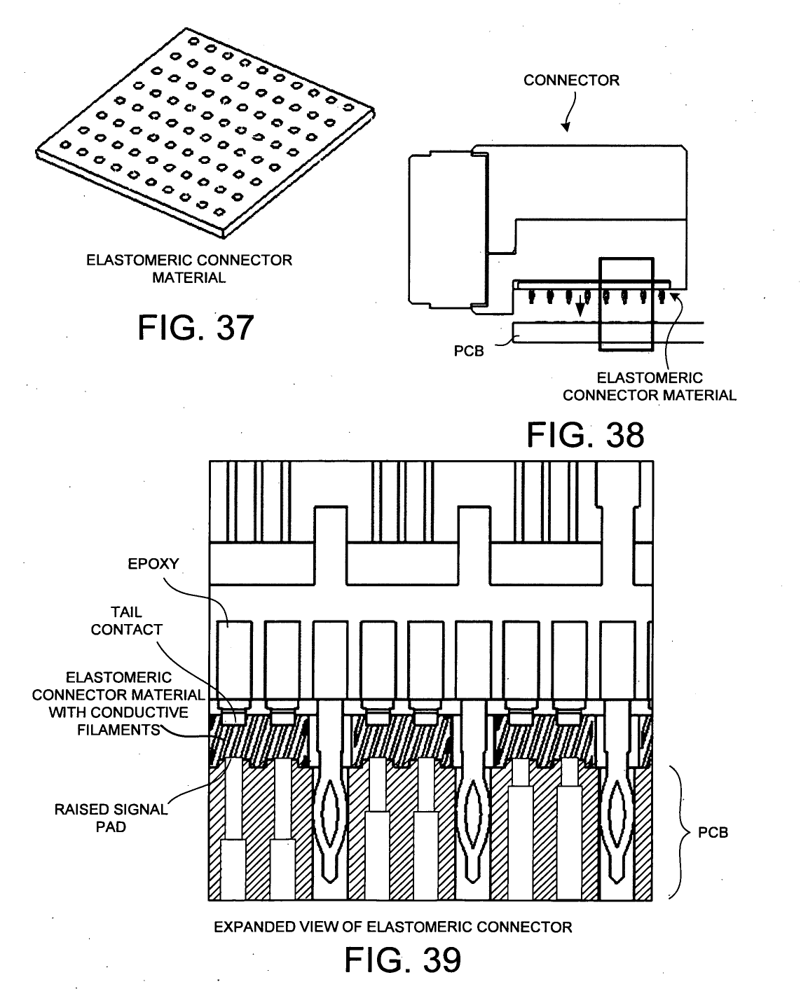

FIGS. 37-39 illustrate an embodiment of a connector employing both press-fit pins and CRSCEs, where the CRSCEs are parts of a single sheet of elastomeric connector material involving many conductive filaments. The elastomeric connector material may be anisotropic (slanted conductive filaments) or isotropic (non-slanted conductive filaments). FIG. 37 is a perspective view of the sheet of elastomeric connector material. FIG. 38 is a side view showing the elastomeric connector material disposed on the bottom of the connector housing. FIG. 39 is an expanded cross-sectional side view of the portion of the connector enclosed by the box in FIG. 38. The conductive filaments in an actual connector are smaller than illustrated relative to the other parts of the connector. The conductive filaments (anisotropic) are shown larger than true scale in FIG. 39 to clarify the diagram. The press-fit pins extend through corresponding holes in the elastomeric connector.

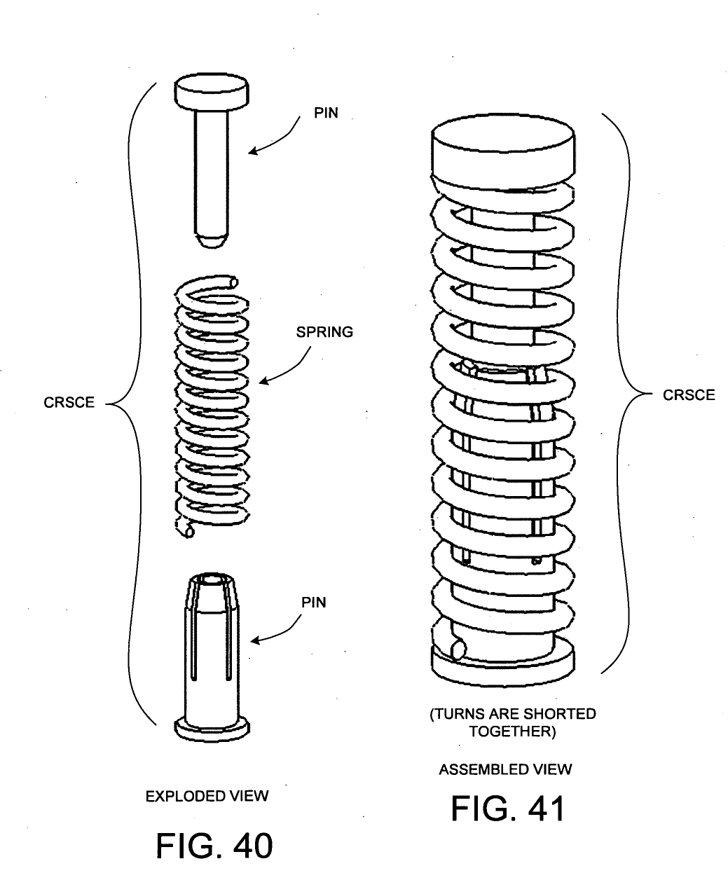

FIGS. 40 and 41 illustrate another embodiment of a CRSCE involving a spring (metal or insulative material) and two conductive pins. FIG. 40 is an exploded view of the CRSCE. FIG. 41 is a view of the CRSCE in its assembled state.

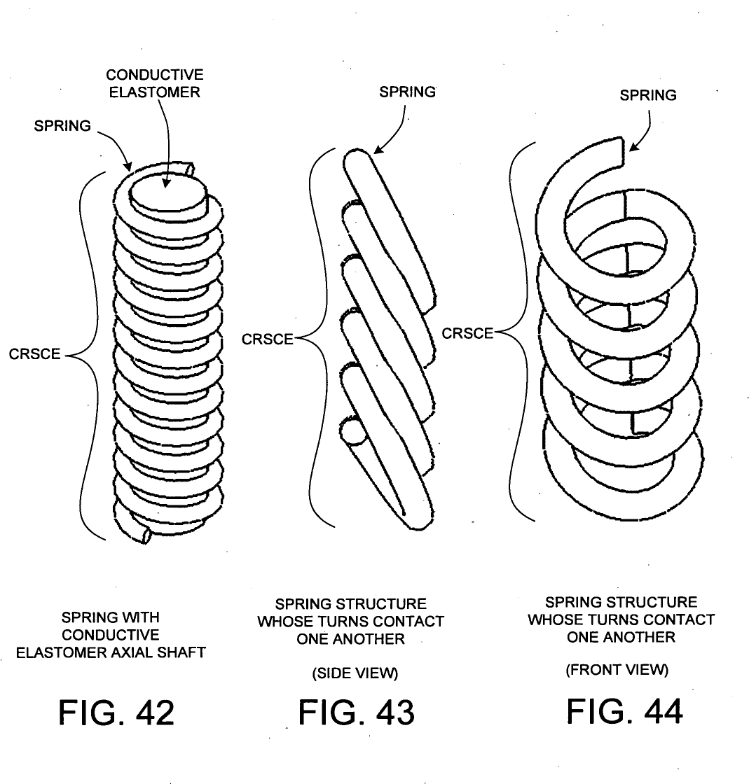

FIG. 42 illustrates an embodiment of a CRSCE involving a spring with a conductive elastomer axial shaft. The spring may be made of metal or an insulative material.

FIGS. 43 and 44 are diagrams of another embodiment of a CRSCE. This CRSCE is a metal spring structure whose turns contact each other to reduce inductance of the structure. FIG. 43 is a side view. Notice that the turns are contacting one another. FIG. 44 is a front view.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. An electrical connector comprising:
a connector body portion having a substantially planar connector body surface;
a plurality of press-fit pins (PFP), wherein each press-fit pin extends from the substantially planar connector body surface; and
a plurality of conductive resilient surface contact elements (CRSCEs), wherein each CRSCE extends from the substantially planar connector body surface, wherein the plurality of PFPs and the plurality of CRSCEs form a two-dimensional array of terminals that extends from the substantially planar connector body surface.

2. The electrical connector of claim 1, wherein each CRSCE extends away from the substantially planar connector body surface and ends in a surface mount contact surface, wherein the surface mount contact surface has an area of less than two square millimeters, wherein the CRSCE is compressible such that the surface mount contact surface of the CRSCE is moved closer to the substantially planar connector body surface when the CRSCE is compressed.

3. The electrical connector of claim 2, wherein each CRSCE is a structure taken from the group consisting of: a fuzz button, a hollow knitted wire mesh tube, a knitted wire mesh tube that surrounds an axially-disposed larger diameter wire, a knitted wire mesh tube that surrounds an axial shaft of elastic material, an amount of a conductive elastic material, an amount of crushed wire mesh material, an elastomeric connector that includes at least one conductive filament, a spring surrounding an axial shaft of a conductive elastomer that shorts turns of the spring, a spring surrounding a metal pin that shorts turns of the spring, a spring structure whose turns contact one another.

4. The electrical connector of claim 2, wherein each CRSCE is partly disposed in a corresponding hole in the connector body portion, wherein each hole has an end, wherein one end of said each CRSCE is attached to the connector body portion near the end of the hole into which a part of the CRSCE is disposed, wherein the CRSCE extends out of the hole and terminates in the surface mount contact surface of the CRSCE.

5. The electrical connector of claim 1, wherein the two-dimensional array includes a plurality of rows of PFPs and CRSCEs, wherein the PFPs and the CRSCEs of a row are arranged such that there are pairs of adjacent CRSCEs, and such that each adjacent pair of CRSCEs is separated by one PFP.

6. The electrical connector of claim 1, wherein there is at least one PFP for each four CRSCEs, and wherein there are at least fifty CRSCEs.

7. The electrical connector of claim 1, wherein the connector body portion includes a plurality of flexible printed circuit (FPC) portions, wherein each FPC portion includes a plurality of signal transmission conductors that extend toward the substantially planar connector body surface, wherein each of the signal transmission conductors has an end that is electrically coupled to a corresponding one of the CRSCEs.

8. The electrical connector of claim 7, said each FPC portion further includes a plurality of ground conductors, wherein each of the ground conductors has an end that is electrically connected to a corresponding one of the PFPs.

9. The electrical connector of claim 1, further comprising:
a laterally displaceable head portion that is movable with respect to the connector body portion, wherein the connector body portion includes a plurality of flexible printed circuit (FPC) portions, wherein the FPC portions bend when the laterally displaceable head portion is moved with respect to the connector body portion.

10. An electrical connector comprising:
an insulative housing portion; and
a plurality of printed circuit (PC) assemblies that are retained by the insulative housing portion, wherein each PC assembly includes
a printed circuit (PC) having a surface;
a plurality of conductive resilient surface contact elements (CRSCEs), wherein each CRSCE does not include any piece of metal having a thickness of more than 0.2 millimeters; and
an insulative cover that engages the surface, wherein the insulative cover forms a plurality of channels, each CRSCE being partly disposed in a corresponding one of the channels.

11. The electrical connector of claim 10, wherein the insulative cover pinches an end portion of each CRE against the surface of the PC such that said each CRSCE is held in place in its corresponding channel.

12. The electrical connector of claim 10, wherein each PC assembly further comprises:
a plurality of press-fit pins (PFPs), wherein each PFP is fixed to the PC of said each PC assembly.

13. The electrical connector of claim 12, wherein the electrical connector has a laterally displaceable head portion, and wherein the PC of each PC assembly is a flexible printed circuit (FPC).

14. A method comprising:
(a) providing a plurality of press-fit pins that extend from a side of a connector; and
(b) providing a plurality of compressible and conductive surface contact elements, wherein each compressible and conductive surface contact element extends from the side of the connector and does not involve any piece of metal having a thickness of more than 0.2 millimeters, and wherein the plurality of press-fit pins and the plurality of compressible and conductive surface contact elements form a two-dimensional array.

15. The method of claim 14, wherein each of the compressible and conductive surface contact elements is a structure taken from the group consisting of: a fuzz button, a hollow knitted wire mesh tube, a knitted wire mesh tube that surrounds an axially-disposed larger diameter wire, a knitted wire mesh tube that surrounds an axial shaft of elastic material, an amount of a conductive elastic material, an amount of crushed wire mesh material, an elastomeric connector that includes at least one conductive filament.

16. A method comprising:
(a) using a plurality of press-fit pins to hold a connector to a printed circuit board;
(b) using a plurality of compressible and conductive surface contact elements to make electrical contact with conductors on the printed circuit board, wherein the plurality of compressible and conductive surface contact elements is compressed between the connector and the printed circuit board, and wherein none of the compressible and conductive surface contact elements involves any piece of metal having a thickness of more than 0.2 millimeters; and
(c) using the plurality of compressible and conductive surface contact elements to conduct signals between the conductors on the printed circuit board and the connector.

17. The method of claim 16, wherein each of the compressible and conductive surface contact elements is a structure taken from the group consisting of: a fuzz button, a hollow knitted wire mesh tube, a knitted wire mesh tube that surrounds an axially-disposed larger diameter wire, a knitted wire mesh tube that surrounds an axial shaft of elastic material, an amount of a conductive elastic material, an amount of crushed wire mesh material, an elastomeric connector that includes at least one conductive filament, a spring surrounding an axial shaft of a conductive elastomer that shorts turns of the spring, a spring surrounding a metal pin that shorts turns of the spring, a spring structure whose turns contact one another.

18. The method of claim 16, further comprising:
(d) supplying a ground potential onto the plurality of press-fit pins.

19. The method of claim 16, wherein none of the compressible and conductive surface contact elements is soldered to the printed circuit board.

20. A connector comprising:
at least ten identical contact means, wherein each contact means is for making an electrical connection between a connector and a printed circuit board by compressing such that a contact surface of the contact means contacts a conductor on the printed circuit board without being soldered to the conductor, wherein the contact surface has an area of less than two square millimeters, and wherein the contact means does not include any piece of stamped sheet metal; and
at least ten press-fit pins that hold the connector to the printed circuit board such that each of the at least ten contact means is held in a compressed condition between the connector and the printed circuit board.

21. The connector of claim 20, wherein electrical signals are communicated through the ten identical contact means between the printed circuit board and the connector when none of the contact means is soldered to the printed circuit board.
